(19) United States
(12) Patent Application Publication
(10) Pub. No.: US 2006/0017397 A1
(43) Pub. Date: Jan. 26, 2006

(54) Two-way switching apparatus

(76) Inventor: Stuart Estabrook, Sarasota, FL (US)

Correspondence Address: HEDMAN & COSTIGAN P.C., 1185 AVENUE OF THE AMERICAS, NEW YORK, NY, 10036, US

(21) Appl. No.: 10/896,248

(22) Filed: Jul. 21, 2004

(51) Int. Cl. H05B 37/02

(52) U.S. Cl. 315/209 R

(57) ABSTRACT

The present invention broadly relates to an apparatus for the control of a device either from a first main or wall switch or from one or more secondary switches located in, on or near the device. More particularly, the present invention relates to an apparatus that allows an electrical device to be turned on or off independently from either said first switch or said secondary switches. Most particularly, the present invention relates to an apparatus comprised of an electromechanical relay switch and one or more other switches that cooperate to regulate the current from an electrical outlet provided to an electrical device.

### FIELD OF INVENTION

The present invention broadly relates to an apparatus for the control of an electrical device either from a first main or wall switch or from one or more secondary switches located in, on or near the device. More particularly, the present invention relates to an apparatus that allows an electrical device to be turned on or off independently from either said first switch or said secondary switches. Most particularly, the present invention relates to an apparatus comprised of an electromechanical relay switch and one or more other switches that cooperate to regulate the current from an electrical outlet provided to an electrical device.

### BACKGROUND OF INVENTION

Over the years, buildings have been equipped with electrical outlets controlled by wall switches. One purpose of this arrangement is to allow electrical devices such as lamps, radios and the like plugged into a wall outlet to be controlled by the switches positioned near an entranceway. One problem that arises with such an arrangement is that, once the device is turned off via its own switch, the wall switch no longer controls the device. One example of this problem is illustrated by a bedside lamp, which, if the switch at the lamp is left on, allows a person entering a dark room to turn on the lamp from the wall switch and avoids the need to search for the lamp switch in the dark.

While it is convenient to turn the lamp on using the wall switch when entering the room after dark, it is more convenient to use the switch near the lamp to turn the lamp off when retiring. As a result, in the morning, when the room is well lit by daylight, the bedside lamp switch is typically left switched off. Thus, at nighttime when the room is reentered, the wall switch cannot be used to turn the lamp on again.

Various apparatuses have been devised to overcome problems of this nature. For example, Platzer, U.S. Pat. No. 3,872,319, relates to a “Lazy-Man Type Switching Circuit;” Bennett, U.S. Pat. No. 5,574,319, relates to “Switching Devices;” and Logan, U.S. Pat. No. 5,574,319, relates to a “Switching Device for Controlling a Lamp from Both a Wall Switch and the Lamp's Switch.” The devices disclosed in the prior art, however, have a number of disadvantages including, for instance, that they are costly to manufacture, difficult to install and complex in their design.

### SUMMARY OF INVENTION

The present invention concerns an apparatus for the control of an electrical device independently either from a first main or wall switch or from one or more secondary switches located in, on or near the device.

Thus, it is an object of the present invention to provide a switching apparatus that is simple in design and relatively inexpensive to manufacture.

It is also an object of the present invention to provide a switching apparatus that may be comprised of no more that a few functioning electrical parts.

It is a further objective of the present invention to provide a switching apparatus that can be easily incorporated into the manufacture of a lamp or other electrical device or added to existing devices.

These and other objectives will become evident to those skilled in the art from the specification.

### BRIEF DESCRIPTION OF THE INVENTION

FIG. 1 depicts one embodiment of the present invention as it applies to a lamp.

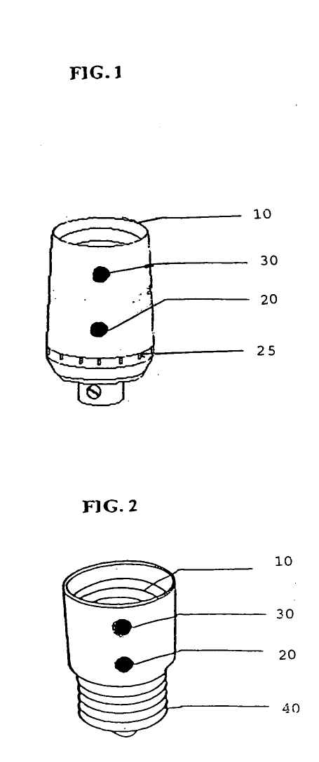

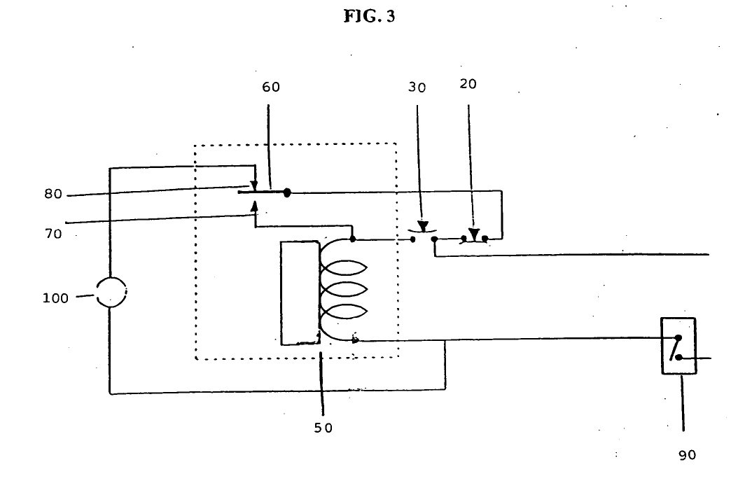

FIG. 2 depicts another embodiment of the present invention as it applies to a lamp.

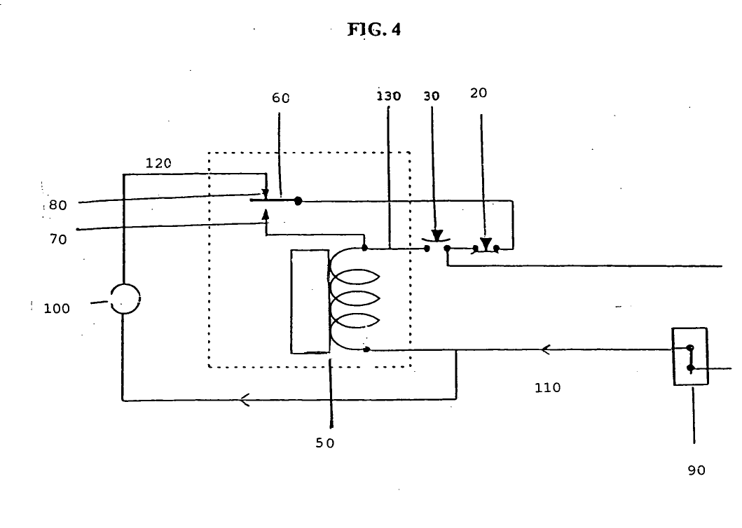

FIGS. 3-5 depict schematic electrical diagrams of an embodiment of the present invention.

### DETAILED DESCRIPTION OF THE INVENTION

The following description of various embodiments is presented to illustrate the present invention and is not to be construed to limit the scope of the claims in any manner whatsoever.

For purposes of illustration, the embodiments described below are described with reference to a lamp, however, it is to be understood the invention is suited to other devices including, but not limited to, radios, nightlights, heaters, fans or the like. Further, although the Figures depict an apparatus that cooperates directly with the bulb of a lamp, the apparatus may be placed elsewhere in the lamp and/or elsewhere on or near the lamp.

The embodiment depicted in FIG. 1 is of an apparatus that is incorporated into the design of the lamp. Therein is shown a socket 10 for a bulb, a secondary on switch 20 and a secondary off switch 30. The design of said switches are further explained with reference to FIG. 3, which is discussed below. Also shown are small indentations 25 that are used as part of the snap-together process used in the construction of many conventional lamp sockets. The relay preferred in the present embodiment produces infinitesimal heat such that there is no need to cool the relay 50 (see FIG. 3). However, in constructing such embodiments of the present invention, one or more of the indentions 25 may be replaced by one or more holes or vents that allow air to circulate so as to cool the relay 50 (see FIG. 3). Other means known to those skilled in the art may also be used to vent the apparatus and are within the full-intended scope of the present invention.

FIG. 2 shows another embodiment of the invention as it applies to a lamp. Therein is shown a bulb socket 10, a secondary on switch 20 and a secondary off switch 30. Again, the design of said switches are further explained with reference to FIG. 3. Also shown is an adapter 40, which cooperates with a socket for light bulb (not shown). Although a screw-thread adapter is shown, any suitable-type adaptor may be used depending on the socket into which the apparatus is to be inserted.

FIG. 3 depicts a schematic electrical diagram of an embodiment of the present invention. The diagram shown in FIG. 3 can be used with the apparatus depicted in FIGS. 1 and 2. Shown therein are a secondary on switch 20, a secondary off switch 30, a relay 50 and an armature 60. Also shown are two contact points 70, 80 for the armature. Further shown are a first main or wall switch 90 and a bulb 100. For purposes of simplicity, the electrical outlet is not shown in the Figures.

The secondary switches 20, 30 depicted are miniature momentary contact, push button switches. However, any suitable switches known to those skilled in the art may be employed. Suitable relays 50 for use with the depicted embodiment include a single pole, double throw electromechanical A/C relay of the voltage used in the country intended. Preferred with regard to the depicted embodiment for use in the United States is a miniature, low current, single pole, double throw, relay of 115 volts alternating current with a milliamp coil and one (1) amp contacts. However, any suitable relay known to those skilled in the art may be employed.

As depicted in FIG. 3, when the wall switch 90 is in the off position, no current is applied to the relay 50 or bulb 100. Further, the armature 60 is in contact with contact point 80, its default position. The secondary on switch 20 is in its default position (closed) and the secondary off switch 30 is in its default position (open).

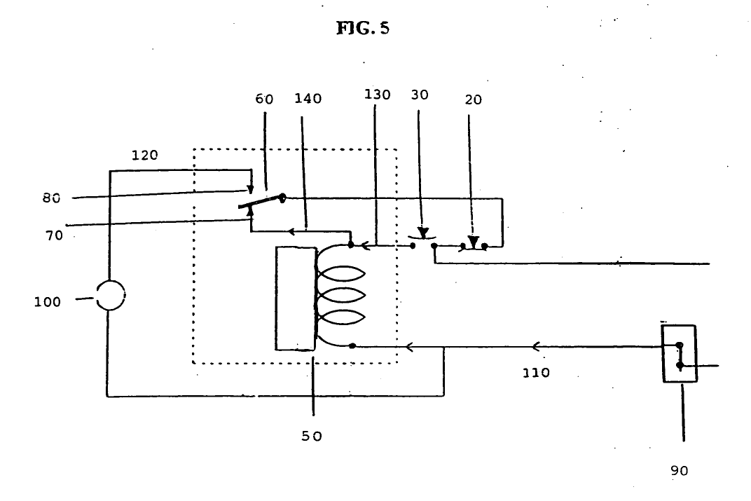

As depicted in FIG. 4, when the wall switch 90 is turned on, electric current flows along path 110 towards the bulb 100 and relay 50. The current is applied to the bulb 100 and the bulb is illuminated because the bulb circuit path 120 is enabled with the armature 60 and secondary switches 20, 30 in their default positions. The current does not activate the relay 50 because the relay circuit path 130 is disabled because the secondary off switch 30 is in its default position (open).

The bulb 100 may now be turned off at the lamp by momentarily depressing the secondary off switch 30. As depicted in FIG. 5, momentarily depressing the secondary off switch 30 allows current to reach and enable the relay circuit path 130 thereby activating the relay 50 and relay switch path 140. Activation of the relay switch path 140 creates an electromagnetic force that moves the armature 60 from its default position to contact point 70. The relay remains on even after the secondary off switch 30 is released, i.e., the armature remains in contact with contact point 70 and the relay circuit path 130 remains enabled. To illuminate the bulb using the apparatus, the secondary on switch 20 is momentarily depressed. Depressing the secondary on switch 20 disables the relay circuit path 130 and the armature 60 springs back to its default position such that the bulb circuit path 120 is again enabled (as depicted in FIG. 4) and the bulb is illuminated. The secondary on switch 20 also springs back to its default position (closed).

In the event that the bulb 100 is turned off using the secondary off switch 30 of the apparatus and the wall switch 90 is in the on position (as depicted in FIG. 5), the bulb may still be turned on using the wall switch. This is done by turning the wall switch 90 to the off position and then back to the on position. Turning the wall switch to the off position cuts the current to the relay 50 and returns the armature 60 to its default position (contact point 80) as depicted in FIG. 3. (The secondary switches are also in their default position.) As depicted in FIG. 4, turning the wall switch 90 back to the on position applies electric current, via path 110, to the bulb 100. The bulb 100 is illuminated because the bulb circuit path 120 is enabled with the armature 60 and secondary switches 20, 30 in their default positions.

Many variations of the present invention will suggest themselves to those skilled in the art in light of the above-detailed description. For example, the apparatus may be used in radios, nightlights, heaters, fans or the like. By way of further example, the secondary on switch may be lit when current flows through it by a means of illumination to assist in seeing the secondary switches in the dark. Such means of illumination are well-known in the art and include, but are not limited to, a bulb or light emitting diode. All such obvious modifications are within the full-intended scope of the claims.

1. A two-way switching apparatus for controlling the operation of a device which is supplied with electric current from an electrical outlet, said electrical outlet being selectively energized in response to the operation of a wall-mounted switch having an OFF position and at least one ON position, said apparatus comprising:
at least one secondary switch for selectively alternating the flow of current from said outlet either to at least one relay or to at least one component of said device;
at least one relay energized in response to the operation of at least one said secondary switch;
wherein said relay is comprised of at least one armature;
wherein said relay when energized disables at least one component of said device;
and wherein said relay is capable of being selectively de-energized independently by either at least one said secondary switch or by said wall-mounted switch; and
wherein said apparatus is further comprised of at least one vent.

2. An apparatus as set forth in claim 1 wherein said apparatus is housed within said electrical device.

3. An apparatus as set forth in claim 1 wherein said apparatus removably attaches to said electrical device.

4. An apparatus as set forth in claim 1 wherein the visible part of at least one said secondary switch is illuminated by an illumination means in response to the operation of said wall-mounted switch.

5. An apparatus as set forth in claim 1 wherein at least one said secondary switch is a momentary contact switch.

6. An apparatus and as set forth in claim 1 wherein at least one said relay is a single pole, double throw electromechanical alternating current relay.

7. An apparatus as set forth in claim 1 wherein said device is a lamp and said component is a light bulb.

8. An apparatus as defined in claim 7 wherein said apparatus is further comprised of an end that cooperates with a socket in a lamp and of an end with a socket that accepts a light bulb.

9. (canceled)

10. A two-way switching apparatus for controlling the operation of a device which is supplied with electric current from an electrical outlet, said electrical outlet being selectively energized in response to the operation of a wall-mounted switch having an OFF position and at least one ON position, said apparatus comprising:
at least one secondary switch for selectively alternating the flow of current from said outlet either to at least one relay or to at least one component of said device;
at least one relay energized in response to the operation of at least one said secondary switch;
wherein at least one said secondary switch is a momentary contact switch;
wherein said relay is a single pole, double throw electromechanical alternating current relay comprised of at least one armature;
wherein said relay when energized disables at least one component of said device;
wherein said relay is capable of being selectively de-energized independently by either at least one said secondary switch or by said wall-mounted switch;
wherein said device is a lamp and said component is a light bulb; and wherein said apparatus is further comprised of at least one vent.

11. A two-way switching apparatus for controlling the operation of a device which is supplied with electric current from an electrical outlet, said electrical outlet being selectively energized in response to the operation of a wall-mounted switch having an OFF position and at least one ON position, said apparatus comprising:
at least one secondary switch for selectively alternating the flow of current from said outlet either to at least one relay or to at least one component of said device;
at least one relay energized in response to the operation of at least one said secondary switch;
wherein at least one said secondary switch is a momentary contact switch;
wherein said relay is a single pole, double throw electromechanical alternating current relay comprised of at least one armature;
wherein said relay when energized disables at least one component of said device;
wherein said relay is capable of being selectively de-energized independently by either at least one said secondary switch or by said wall-mounted switch;
wherein said apparatus is further comprised of an end that cooperates with a socket in a lamp and of an end with a socket that accepts a light bulb; and
wherein said apparatus is further comprised of at least one vent.
